(19) United States
(12) Patent Application Publication
(10) Pub. No.: US 2007/0252003 A1
(43) Pub. Date: Nov. 1, 2007

(54) Interactive kiosk and method for vending items using same

(75) Inventors: Fred E. Goldring, Beverly Hills, CA (US); Kenneth B. Hertz, Beverly Hills, CA (US); Philip Sandhaus, Beverly Hills, CA (US); David W. Schultze, Pasadena, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: MEMBRAIN, LLC, Beverly Hills, CA (US)

(21) Appl. No.: 11/413,488

(22) Filed: Apr. 27, 2006

(51) Int. Cl. G06F 7/08

(52) U.S. Cl. 235/381

(57) ABSTRACT

An interactive kiosk that can be placed in a retail environment. The kiosk includes a main body portion, a plurality of user interfaces disposed on the outer face of the main body portion, dispensing system disposed in the interior of the main body portion, and a central processing unit. The main body portion has an inner face, an outer face, an interior and an exterior, and includes a plurality of dispensing slots defined therein. The dispensing system includes first and second rows of dispensers disposed on the inner face of the main body portion. Each of the dispensers is in electrical communication with the central processing unit. The dispensing system also includes a top funnel having an opening defined therein associated with the first row of dispensers, and a bottom funnel having an opening defined therein associated with the second row of dispensers. The dispensing system also includes a slide tray assembly disposed below the at least one funnel. The slide tray assembly is adapted to dispense items to the dispensing slots.

### FIELD OF THE INVENTION

The present invention relates to an interactive kiosk, and more particularly to an interactive kiosk that includes user stations and that will be integrated into retail store environments.

### BACKGROUND OF THE INVENTION

In today's busy world, people often do not have time to shop for certain items, such as music. Accordingly, a need exists for a convenient and efficient way to purchase music and other items while shopping for other essentials, such as food and the like.

### SUMMARY OF THE PREFERRED EMBODIMENTS

In accordance with a preferred embodiment of the present invention there is provided a method of vending items. The method includes the steps of providing an unmanned kiosk having an exterior and an interior, accepting a user interaction with a user interface associated with the exterior of the kiosk, adjusting a slide tray assembly, dispensing from a dispenser an item located in the interior of the kiosk, sliding the item down the slide tray assembly, and receiving the item in a dispensing slot that communicates the interior and exterior of the kiosk.

In accordance with another preferred embodiment of the present invention there is provided a main body portion having an inner face, an outer face, an interior and an exterior, a central processing unit, at least one user interface disposed on the outer face of the main body portion that is in electrical communication with the central processing unit, and a dispensing system disposed in the interior of the main body portion. The main body portion includes at least one dispensing slot defined therein. The dispensing system includes at least one dispenser disposed on the inner face of the main body portion that is in electrical communication with the central processing unit, at least one funnel with an opening defined therein associated with the at least one dispenser, and a slide tray assembly disposed below the at least one funnel. The slide tray assembly is adapted to dispense items to the at least one dispensing slot.

In a preferred embodiment, the slide tray assembly includes a double ended slide tray having first and second slide portions, and a bridge. The bridge is pivotable by a motor drive to form a first slide path with the first slide portion and a second slide path with the second slide portion.

In accordance with yet another preferred embodiment of the present invention there is provided an interactive kiosk that can be placed in a retail environment. The kiosk includes a main body portion, a plurality of user interfaces disposed on the outer face of the main body portion, a dispensing system disposed in the interior of the main body portion, and a central processing unit. The main body portion has an inner face, an outer face, an interior and an exterior, and includes a plurality of dispensing slots defined therein. The dispensing system includes first and second rows of dispensers disposed on the inner face of the main body portion. Each of the dispensers is in electrical communication with the central processing unit. The dispensing system also includes a top funnel having an opening defined therein associated with the first row of dispensers, and a bottom funnel having an opening defined therein associated with the second row of dispensers. The dispensing system also includes a slide tray assembly disposed below the at least one funnel. The slide tray assembly is adapted to dispense items to the dispensing slots.

In accordance with another preferred embodiment of the present invention there is provided a method of purchasing an entertainment related item. The method includes the steps of entering a fast food establishment, approaching a system for the preview and purchase of entertainment related items, interacting with a user interface associated with the system for the preview and purchase of entertainment related items, and purchasing an entertainment related item.

### BRIEF DESCRIPTION OF THE DRAWINGS

FIG. 1 is a perspective view of an interactive kiosk used for implementing a system for the preview and purchase of items in accordance with a first preferred embodiment of the present invention;

FIG. 2 is a front elevational view of the interactive kiosk of FIG. 1;

FIG. 3 is a top plan view of the interactive kiosk of FIG. 1;

FIG. 4 is a perspective view of the interactive kiosk of FIG. 1 with an access door open showing a first preferred embodiment of a dispensing system therein;

FIGS. 5a-5h are a series of perspective views of the interior of the interactive kiosk of FIG. 1 showing a CD being dispensed from the first preferred embodiment of the dispensing system;

FIG. 6 is a detailed view of a second preferred embodiment of a dispensing system that can be used with the interactive kiosk of FIG. 1;

FIG. 7 is a perspective view of the interactive kiosk of FIG. 1 with the access door open showing the second preferred embodiment of the dispensing system therein; and

FIGS. 8a-8i are a series of perspective views of the interior of the interactive kiosk of FIG. 1 showing a CD being dispensed from the second preferred embodiment of the dispensing system.

FIG. 9 is a block diagram of a computer system that may be used for implementing the system for the preview and purchase of items of FIG. 1, configured in accordance with a preferred embodiment of the present invention;

Like numerals refer to like parts throughout the several views of the drawings.

### DESCRIPTION OF THE PREFERRED EMBODIMENTS

As shown in the drawings, for purposes of illustration, the invention is embodied in a system for the preview and purchase of items, such as music. In one preferred embodiment, the system is presented to users by an interactive kiosk 10 for previewing, displaying and dispensing the items. Generally, the kiosk 10 is a computer driven system placed in a retail environment so as to induce a consumer or customer to interact with, and benefit by or from, the kiosk. The interactive kiosk 10 is used for displaying, previewing and merchandising articles such as compact discs (CDs), digital video discs (DVDs), video games, tapes and the like and is an independent, stand-alone, unattended or unmanned (by any type of store employee) unit that interacts with a consumer via at least one and preferably a plurality of user interfaces 12.

For exemplary purposes only, described hereinbelow is a preferred embodiment wherein the interactive kiosk is used to display and dispense music, and, in particular, CDs 11 (and the jewel cases in which they are stored). However, this is not a limitation on the present invention. It will be understood that the interactive kiosk can be used to display and dispense other items such as DVDs, video games, digital music, concert tickets, phone cards, merchandise, etc. (referred to herein as entertainment related items). Other uses for the interactive kiosk will be readily apparent to those skilled in the relevant art. In another embodiment, the kiosk or dispenser systems can be used to dispense items other than entertainment related items. Orders for items not available directly from the kiosk can also be placed. For example, at a kiosk that has the top twenty CDs of the week for direct sale, a customer can order an older, more obscure CD for delivery to his/her home or other location.

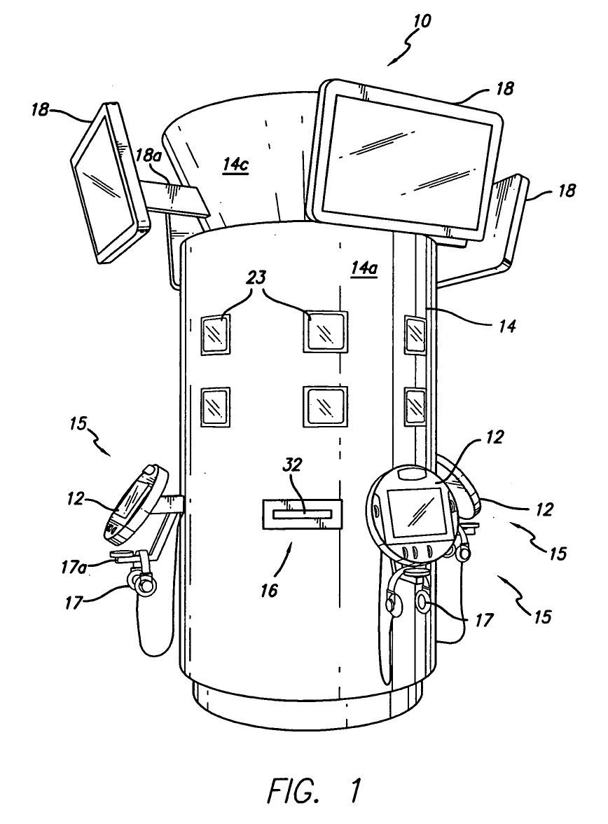

It is contemplated that the present kiosk 10 would be placed in a retail environment, such as a fast food establishment, like McDonald's, or a department store, like Macy's. This affords customers an opportunity to interact with and purchase items from the kiosk while at the retail location to shop for or purchase other items, such as food or household wares. Accordingly, it is contemplated that the embodiment of the present system in the form of an interactive kiosk would prove most acceptable to retailers and the public in general; however, structures other than the particular kiosk 10 shown in FIG. 1 may also be used to accommodate or house the various components of the present system. Also, the kiosk 10 can be configured from varying styles, colors and shapes depending on the retailer's requirements.

The system described herein can be used by retailers who want to offer the preview and purchase of music as a value proposition to their customers. At retail locations, such as McDonald's, the music can be vended as physical CDs dispensed from the kiosk 10. In another embodiment, the customer can receive a receipt or ticket from the kiosk to be redeemed at a counter, window or the like.

The customer interacts with the user stations 15, that preferably include a listening post, and that can facilitate browsing of merchandise and performance of transactions. For example, the customer can listen to songs or read about songs, artists, games or movies at the user station 15. In another embodiment, the kiosk can provide digital downloads (either by burning CDs with the customer's chosen songs and/or direct downloads to digital music players (such as mp3 players or other storage devices) or music compilations that are unique to the retail outlet at which the kiosk is located. The customer-chosen-content burned CDs can be delivered to the customer by the kiosk or by other means, such as mail. The CDs can be delivered in cases that include full artwork and packaging that is chosen by the customer or the retail location.

Generally, the kiosk is a destination that can primarily offer physical CDs and other merchandise through vending, and secondarily, digital content for downloading that is totally responsive to market behavior and trends. The kiosk environment will also incorporate a high resolution, state-of-the-art monitor system featuring entertainment, informational, and promotional content (described more fully hereinbelow). The system will make the retail outlet in which the kiosk is located an entertainment destination for its customers.

It will be appreciated that terms such as “front,” “back,” “top,” “bottom,” and “side” used herein are merely for ease of description and refer to the orientation of the components as shown in the figures. It should be understood that any orientation of the interactive kiosk, and the components thereof described herein is within the scope of the present invention.

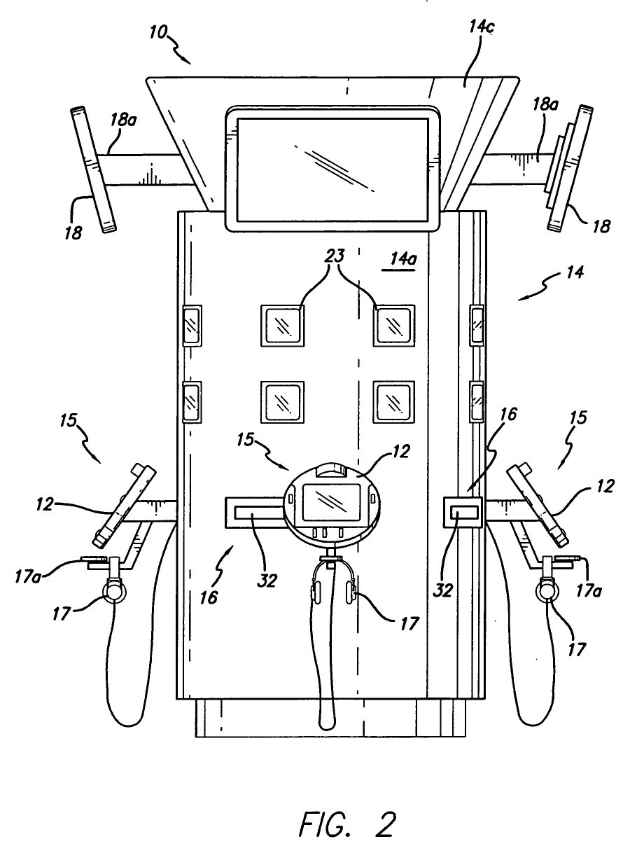

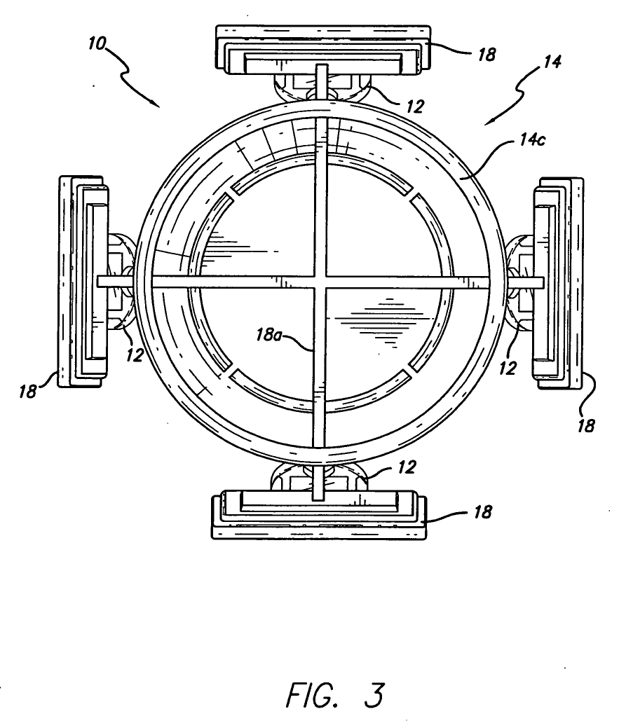

Referring to FIGS. 1-3, generally, the interactive kiosk 10 includes a main body portion 14, a plurality of user stations 15, and a plurality of displays 18. The user stations 15 can include a number of different components that are beneficial to the users experience of previewing and/or purchasing music and other entertainment. In a preferred embodiment, the user stations 15 include a user interface 12, a dispensing area 16 and a pair of headphones 17 among other components. The user interfaces 12 are disposed on the outer face of the main body portion 14. In other words, they are positioned about the periphery of the main body portion 14, whether they extend outwardly from the main body portion 14 or are located in a cubby hole or the like defined in the main body portion 14.

The headphones 17 can be placed on a headphone rack 17a when not in use. The number and types of components of each user station 15 are not to be construed as a limitation on the present invention. For example, besides those components described above, the user stations 15 can also include joysticks or controllers for video game play, multiple headphones, multiple video screens, benches, trays, counters, printed information, speakers, printers, keyboards, rollerballs, mice, serial, parallel and USB ports, and/or digital music player or laptop docks, etc.

The user stations 15 and the user interfaces 12 can include a plurality of functions, including, but not limited to, a listening station, payment terminal, information station, browser, etc. For exemplary purposes only, one. type of user interface 12 that can be used in the present invention is the RedDotNet System (or “Dot”), manufactured by RedDotNet of Carlsbad, California. The Dot was designed specifically for demanding retail applications. The Dot includes a high resolution screen that is capable of displaying full motion video. It also includes a thumbwheel interface to allow fast effective customer interaction.

The user interface 12 can include a transparent interactive overlay which permits a customer to directly select items with a stylus or by means of a touch screen. A fixed alphanumeric keyboard can also be used for customer input of alphanumeric and other information. A credit card or debit card reader module, receipt printer and a cash receiver can also be provided.

The interactivity of the user interface 12 allows the user to browse or search in many different manners. For example, a user can search by song, album, artist, movie, game, genre, top sellers, new releases, etc.

The user interface 12 is in electrical communication with an in-store server/central processing unit (“CPU”) 22 that stores the desired data. For example, the in-store server 22 can store digital music, film, video and game previews, pricing information, trivia, artist information and the like. The in-store server 22 can also hold an extensive product database that can extend far beyond entertainment. Also, the in-store server 22 can include a DVD player (not shown) for playback on each monitor 18. The user interfaces 12 communicate with the content server 22 over a local area network (LAN). It should be understood that the type of user interface used is not a limitation on the present invention.

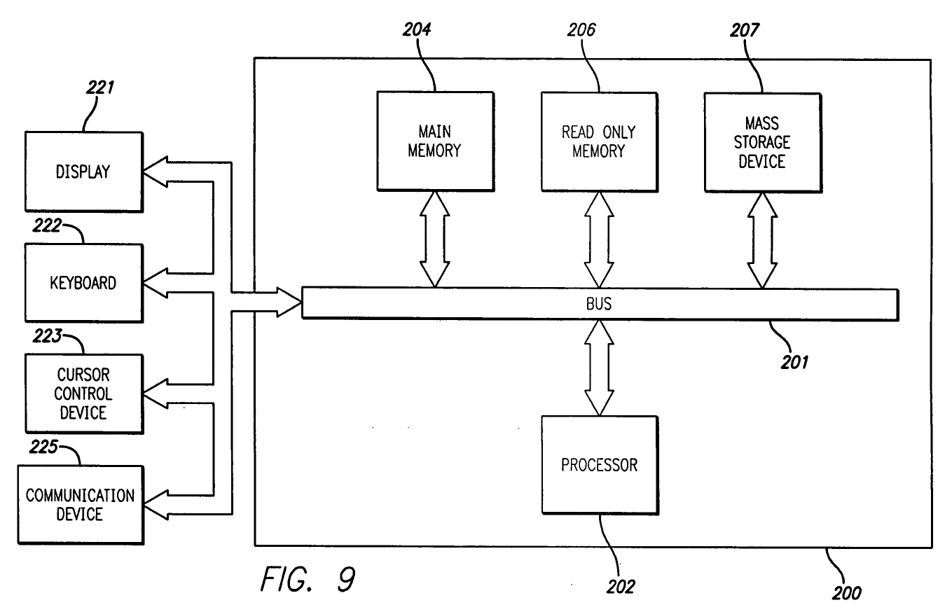

FIG. 9 illustrates an example of a computer system 200 in which the features of the present invention may be implemented (for example, with the in-store server/CPU 22 and user interfaces, among other components). The computer system 200 includes a bus 201 for communicating information between the components in the computer system 200, and a processor 202 coupled with the bus 201 for executing software code, or instructions, and processing information. The computer system 200 further comprises a main memory 204, which may be implemented using random access memory (RAM) and/or other random memory storage device, coupled to the bus 201 for storing information and instructions to be executed by the processor 202. The main memory 204 also may be used for storing temporary variables or other intermediate information during execution of instructions by the processor 202. The computer system 200 also includes a read only memory (ROM) 206 and/or other static storage device coupled to the bus 201 for storings tatic information and instructions for processor 202.

Further, amass storage device 207, such as a magnetic disk drive and/or or a optical disk drive, may be coupled to the computer system 200 for storing information and instructions. The computer system 200 can also be coupled via bus 201 to a display device 221, such as a cathode ray tube (CRT) or a liquid crystal display (LCD), for displaying information to a user so that, for example, graphical or textual information may be presented to the user on the display device 221. Typically, an alphanumeric input device 222, including alphanumeric and other keys is coupled to the bus 201 for communicating information and/or command the user can selections to the processor 202. Another type of user input device show in the figure is a cursor control device 223, such as a conventional mouse, touch mouse, trackball, track pad or other type of cursor direction keys for communicating direction information and command selection to the processor 202 and for controlling movement of a cursor on the display 221. Although not illustrated, the computer system 200 may optionally include video, camera, speakers, sound card, and many other conventional multimedia options (and other components as described herein). Various types of input devices, including, but not limited to the input devices described herein unless otherwise noted, allow the user to provide command or input to the computer system 200. For example, in the various descriptions contained herein, reference may be made to a user “interfacing with,” “selecting,” “clicking,” or “inputting,” and any grammatical variations thereof, one or more items in a user interface. These should be understood to mean that the user is using one or more input devices to accomplish the input.

A communication device 225 is also coupled to the bus 201 for accessing other computer systems, as described below. The communication device 225 may include a modem, a network interface card, or other well-known interface devices, such as those used for interfacing with Ethernet, Token-ring, or other types of networks. In any event, in this manner, the computer system 200 may be coupled to a number of other computer systems via a network infrastructure such as the infrastructure illustrated and described herein.

In a preferred embodiment, the in-store servers 22 of a plurality of interactive kiosks at different retail locations are interconnected. This can be done, for example, through a wide area network (WAN) and can allow updates to the in-store servers 22 to be done from a central location.

It will be understood by those skilled in the art that the main body portion 14 can be constructed in a number of different ways. For example, as shown in the figures, the main body portion 14 can include a wood or metal frame that is covered by plastic, wood, sheet metal or other material. For example, the main body portion 14 can be made of a light-weight metal for durability. As shown in FIG. 1, the main body portion 14 can also include a plurality of windows 23 that display the CDs 11 for sale at the kiosk 10. The manner of construction of the main body portion is not a limitation on the present invention.

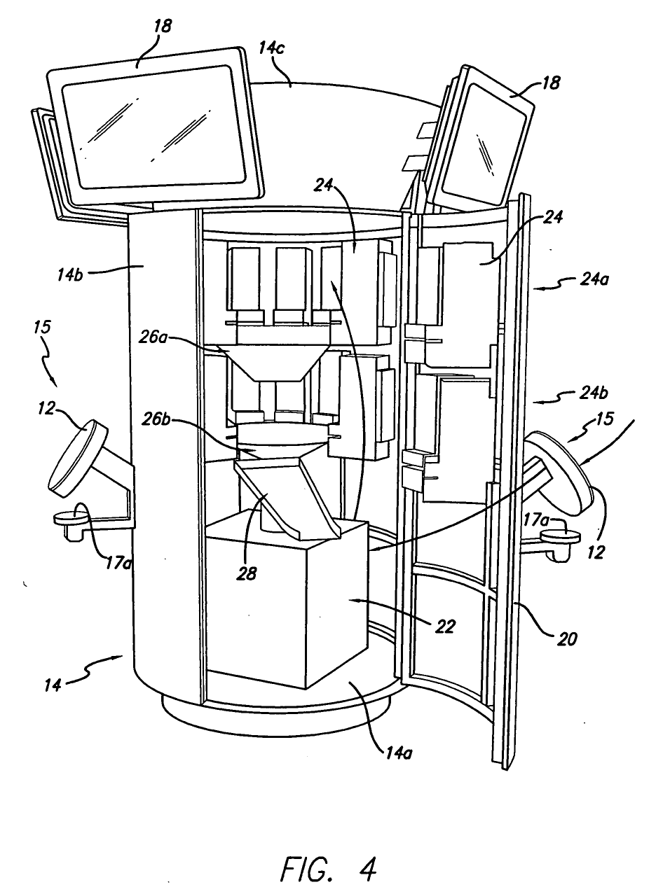

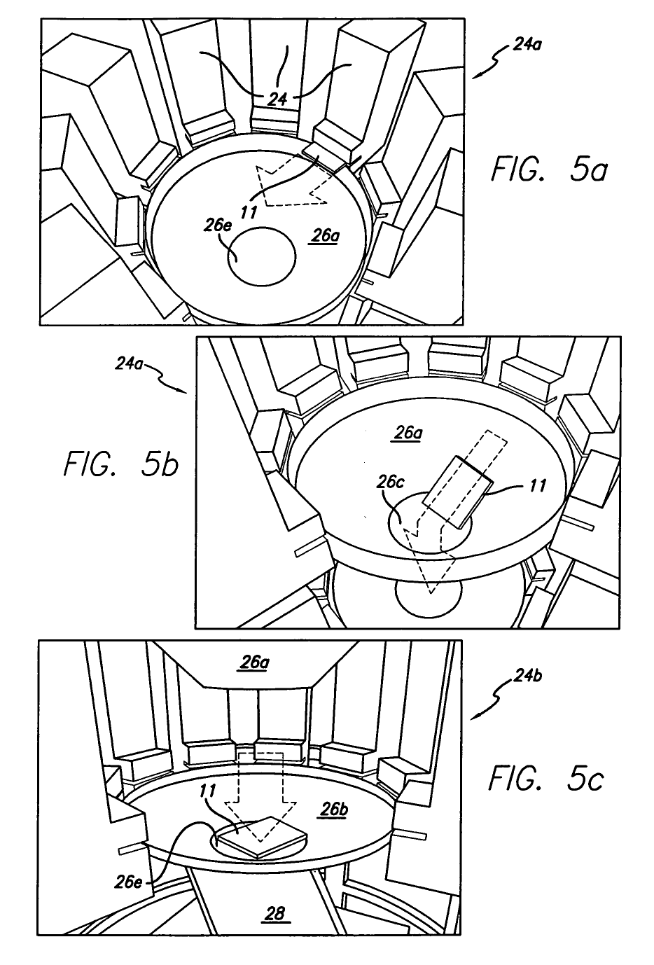

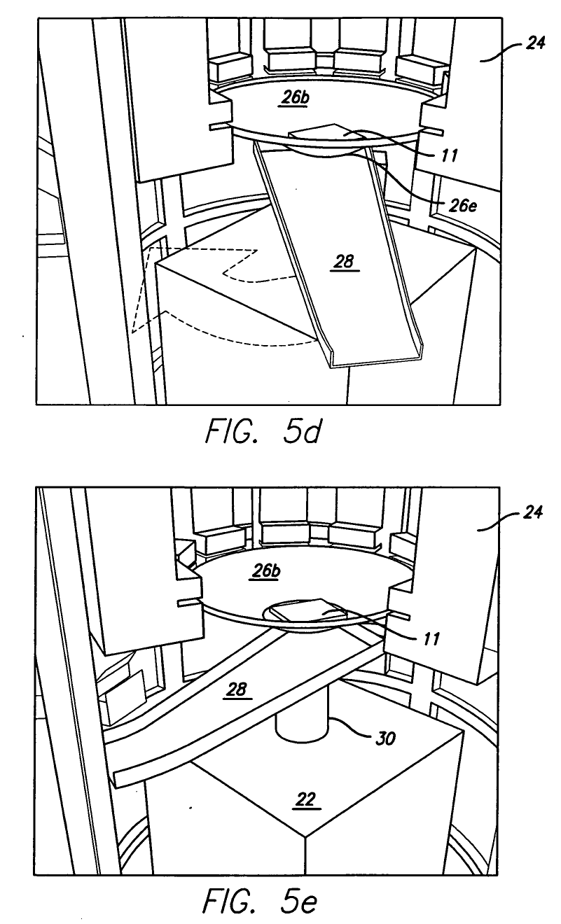

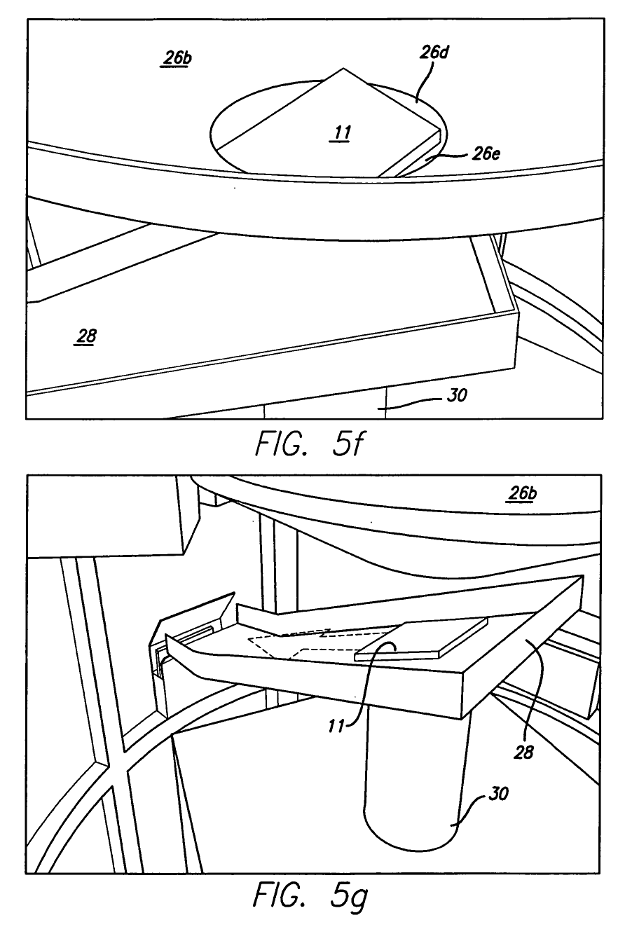

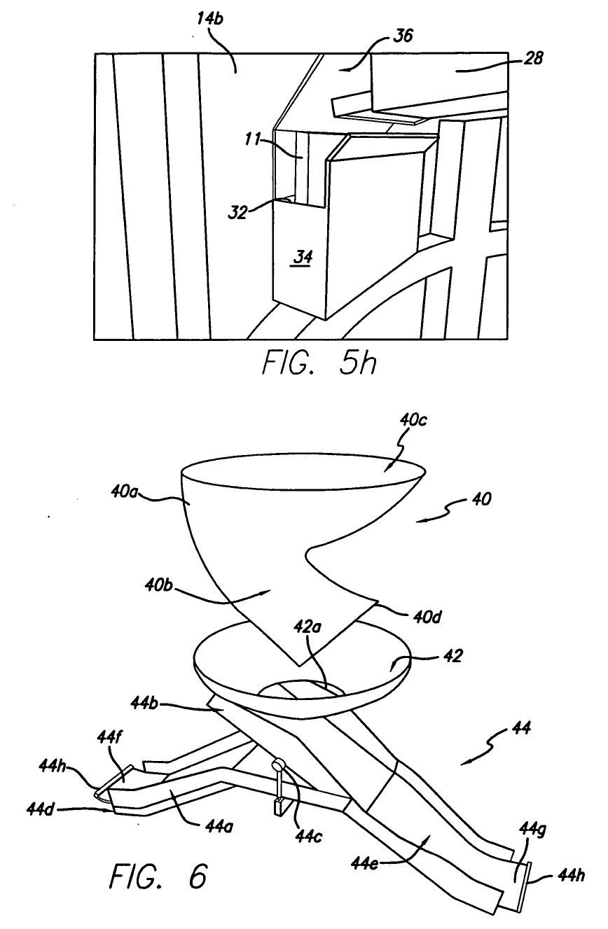

FIGS. 4-5h show a first embodiment of a plurality of interior components that comprise a dispensing system for the interactive kiosk 10. As shown in FIG. 4, the main body portion 14 includes an access door 20, which provides access to the interior 14a thereof. The main body portion 14 has a generally cylindrical shape, however, this is not a limitation on the present invention. The main body portion 14 can be any advantageous shape to fit the area in which it is to be placed inside the retail location. The interior 14a of the main body portion 14 includes a plurality of dispensers 24, a top funnel 26a, a bottom funnel 26b, a slide tray assembly 28 and the in-store server 22.

For exemplary purposes only, one type of dispenser that can be used is the IM-CD1 CD or DVD dispenser manufactured by Technik Mfg., Inc. of Columbus, Nebr. The exemplary dispensers 24 are single column dispensers for enveloped or jewel cased dispensing of full sized CDs and DVDs. It features front-loading of CDs. The dispensers can include serial or parallel control boards for communication with the user interfaces 12 and/or the in-store server 22. The dispenser 24 can include a belt dispensing mechanism or the like. It should be understood that the type of dispenser used is not a limitation on the present invention.

In a preferred embodiment, the dispensers 24 each contain a different CD 11 (i.e., each dispenser dispenses a different album) and are arranged in a plurality of rows (designated top row 24a and bottom row 24b in the figures) that extend around and are secured to the interior surface of the main body portion 14. The top funnel 26a is associated with the top row 24a of dispensers 24 and the bottom funnel 26b is associated with the bottom row 24b of dispensers. In the exemplary embodiment, the dispensers 24 are arranged in two rows 24a and 24b of ten dispensers 24 each. The dispensers 24 are oriented to face inwardly to define a common dispensing zone in the center of the interior 14a of the main body portion 14. It will be understood that the number of dispensers and the number of rows of dispensers is not a limitation on the present invention. Any number of dispensers or rows of dispensers is within the scope of the present invention.

In a preferred embodiment, the funnels 26a and 26b are secured to the dispensers 24 at a point below where the CD 11 exits from the dispensers 24. This allows the CD 11 to drop from the dispenser 24 into the funnel 26a or 26b (as shown in FIGS. 5a-5b). It will be understood that any method or way of associating the funnels with the rows of dispensers is within the scope of the invention, as long as the CDs 11 are dispensed from the dispensers and into the funnel. For example, the funnels can be secured to the dispensers, the inside surface of the main body portion, suspended from wires or the like from the top of the main body portion 14 or supported on components from the bottom of the main body portion 14.

The top funnel 26a includes an opening 26b defined in the middle thereof. The opening 26c is sized so that a CD 11 can fit therethrough (as shown in FIG. 5b). The bottom funnel 26b includes a similar sized opening 26d defined therein. The opening 26d is covered by a trap door 26e that is normally closed (as shown in FIGS. 5c and 5d). Preferably, the door 26e is pivotably attached to the bottom funnel 26b and can be opened at the appropriate time (as determined and controlled by the firmware and/or CPU) to allow a CD 11 resting thereon to drop through opening 26d and onto the slide tray assembly 28 positioned therebelow (as is shown in FIG. 5f). The funnels and slide tray assembly can be made out of any rigid material. In a preferred embodiment, they are made out of a flexible plastic to absorb the impact and protect the jewel cases in which CDs are stored.

In a preferred embodiment, the slide tray assembly 28 is rotatable (as is shown in FIG. 5d). This can be done by securing the slide tray assembly 28 to a rotatable shaft 30, which is in electrical communication with the CPU. The slide tray assembly 28 is preferably rotatable to a plurality of predetermined positions that are associated with the dispensing area 16 of each of the user stations 15 (as is shown in FIG. 5e). With this arrangement, as described more fully below, the CD 11 can be dispensed to the dispensing area 16 of the user station 11 from which the order for the CD 11 was placed (as is shown in FIGS. 5g-5h).

As is shown in FIGS. 1 and 5h, in a preferred embodiment, the dispensing area 16 includes a dispensing slot 32 that is defined in the main body portion 14. The dispensing slot 32 communicates the interior 14a of the main body portion 14 with the exterior 14b thereof. This allows the CDs 11 to be dispensed from the interior 14a, where they are not seen, to the exterior 14b for retrieval by a user. Preferably, the dispensing slot 32 has a tray 34 or the like associated with it for holding the CD 11 after it is dispensed. In a preferred embodiment, the dispensing area 16 also includes an angled bumper 36 or the like for directing the CD 11 into the tray 34.

As shown in FIGS. 1-4, in a preferred embodiment, The kiosk 10 can also incorporate a high resolution, state-of-the-art monitor system featuring entertainment, informational, and promotional content. In this manner, the kiosk 10 includes a plurality of displays or monitors 18 situated about the top thereof. The monitors 18 can also have speakers associated therewith. As shown in the figures, the top 14c of the main body portion 14 can have a cone shape from which a plurality of supports 18a protrude and which include a monitor 18 secured to an end thereof. The cone shape allows for recessed lighting in the main body portion 14 and improves the overall aesthetics of the kiosk 10. The monitors 18 can show movies, previews, clips about the music and/or other items for sale at the kiosk, and advertising and other information, etc.

Referring to FIGS. 4-5h, described hereinbelow is an example of a customer ordering a CD from the interactive kiosk 10 and the steps that occur during the dispensing of the CD therefrom (for this example the chosen CD is located in a dispenser in the top row 24a).

First, a customer approaches a user station 15. Using the user interface 12, one of the CDs 11 in stock is selected by the customer (i.e., the customer places an order and otherwise completes a purchasing transaction). The user interface 12 firmware then communicates (via the CPU) to the dispenser 24 associated with that CD 11 that the CD 11 has been selected (the customer input and electrical communication between the user interface 12, in-house server/CPU 22 and dispensers 24 are shown in FIG. 4 by the dotted arrows). Next, the appropriate dispenser dispenses the purchased CD 11 (see FIG. 5a). The purchased CD 11 then slides down the incline of the top funnel 26a and falls through the opening 26c in the middle thereof (see FIG. 5b). The CD 11 then lands on the trap door 34 in the bottom funnel 26b (see FIG. 5c).

Next, the slide tray assembly 28 is activated and is rotated to face the corresponding dispensing area 16 (see FIGS. 5d-5e). The trap door 34 then opens and the purchased CD 11 drops onto the slide tray assembly 28 (see FIG. 5f). The purchased CD 11 then slides down the slide tray 26 towards the dispensing slot 32 (see FIG. 5g). The purchased CD 11 is then received in the dispenser area 16 (see FIG. 5h), at which point the customer can retrieve the purchased CD 11.

It will be understood that if the CD chosen is dispensed from a dispenser in the bottom row 24b, that the CD will be dispensed directly into the bottom funnel 26b and will never pass through the top funnel 26a.

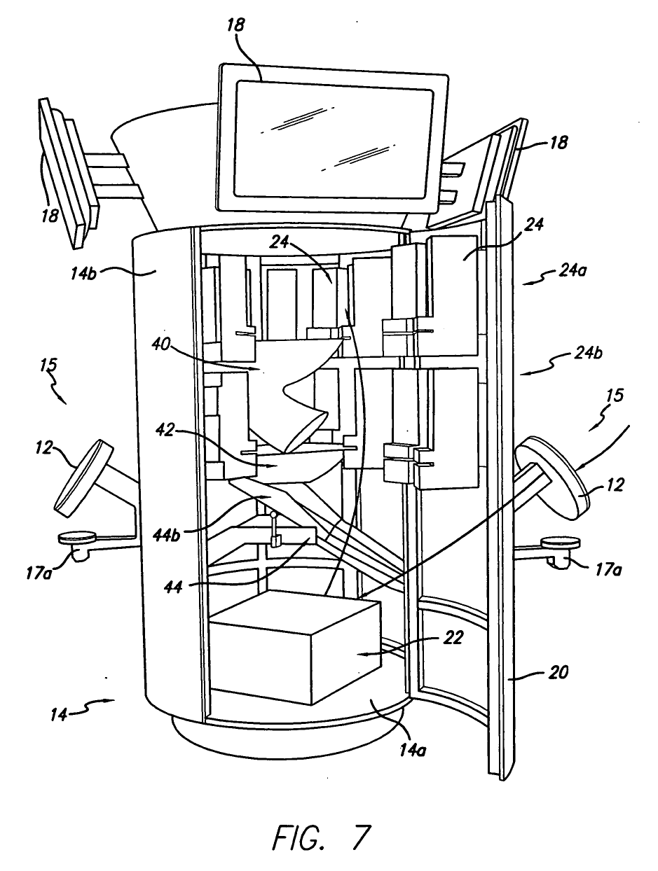

FIGS. 6-8i show a second embodiment of a plurality of interior components that comprise a dispensing system for the interactive kiosk 10. As shown in FIGS. 6-7, the interior 14a of the main body portion 14 includes a plurality of dispensers 24, a top funnel 40, a bottom funnel 42, a slide tray assembly 44 and the in-store server 22.

The top funnel 40 includes a top portion 40a and a bottom portion 40b which cooperate to form an angled chute 40c through which the CDs pass. The angled chute 40c ends in an opening 40d formed in the bottom portion 40b through which CDs 11 drop. This cooperative arrangement of the top portion 40a, bottom portion 40b and angled chute 40c slows CDs down as they fall through the funnel 40. In another embodiment the funnel 40 may include a different shaped chute, for example helical or other shape that can prevent the CDs from dropping too fast (i.e., preventing damage). The bottom funnel 42 also has an opening 42a defined therein through which a CD can pass.

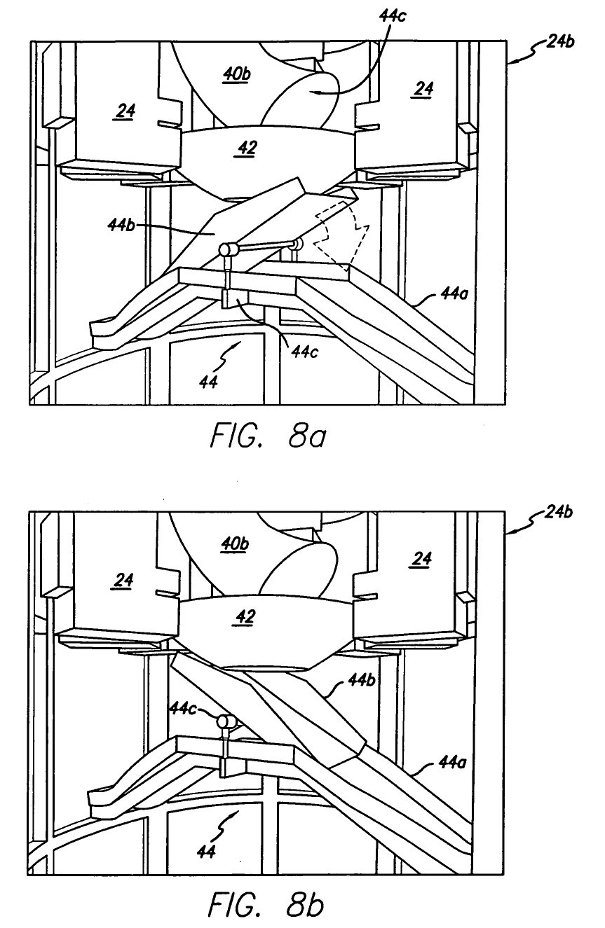

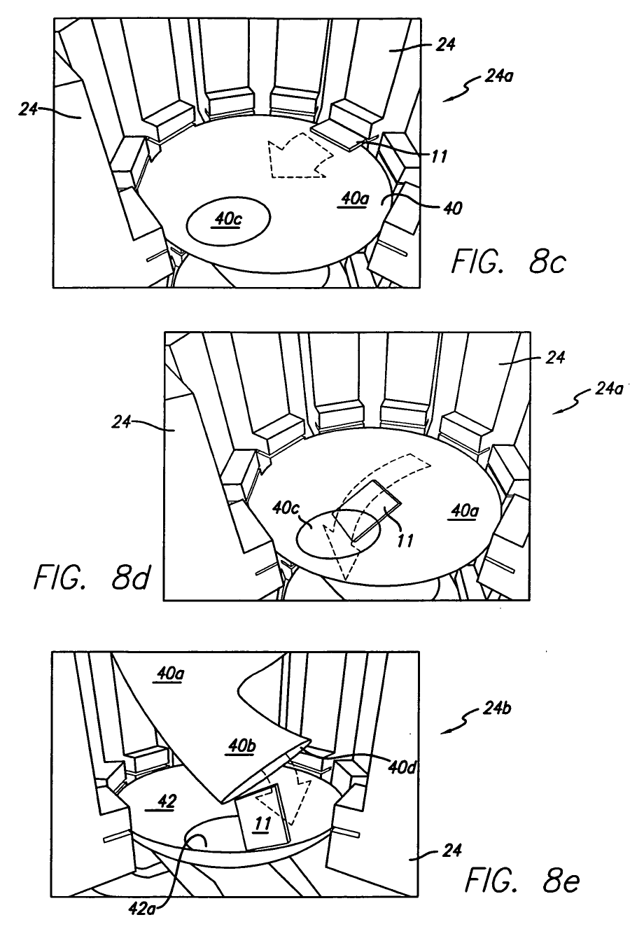

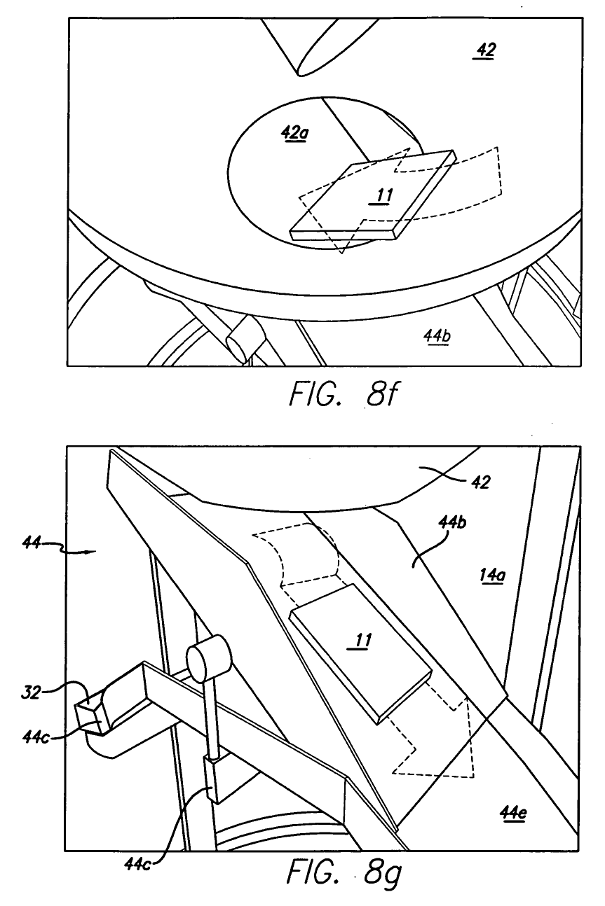

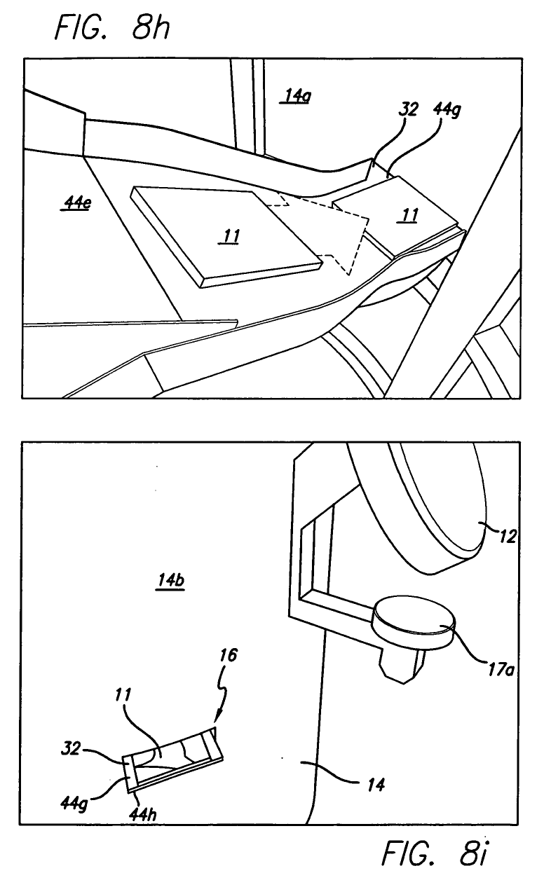

The slide tray assembly 44, which is positioned below the bottom funnel 42, includes a double ended slide tray 44a, a bridge 44b and a motor drive 44c for moving the bridge. The double ended slide tray 44a includes a first slide portion 44d and a second slide portion 44e. The bridge 44b is pivotable from a first position to a second position. In the first position, the bridge 44b forms a first slide path with the first slide portion 44d and in the second position, the bridge 44b forms a second slide path with the second slide portion 44e (as shown in FIGS. 8a-8b). The first and second slide paths direct the CD 11 toward the correct dispensing area 16. It will be understood that only two dispensing areas 16 (and therefore two dispensing slots 32) are needed in this embodiment.

As is shown in FIGS. 6 and 8i, the first and second slide portions 44d and 44e each preferably include an extension 44f and 44g, which each include a stop 44h on the end thereof. The extensions 44f and 44g extend through the corresponding dispensing slot 32 in the main body portion 14 and the stops 44h prevent the CD 11 from sliding off the end thereof.

The bridge 44b is pivoted by the motor drive 44c and its associated components (best shown in FIGS. 8a and 8g), which includes firmware and is in electrical communication with the CPU/in-store server 22. The motor drive 44c is preferably a stepper drive motor that includes a pivot hinge with motor assist for pivoting the bridge 44b.

In another embodiment, the slide tray assembly 44 can be rotatable (similar to the embodiment described above) so that it can service more than two dispensing areas 16.

Referring to FIGS. 7-8i, described herein is an example of a customer ordering a CD from the interactive kiosk 10 and the steps that occur in the dispensing of the CD therefrom (for this example the chosen CD is once again located in a dispenser in the top row 24a).

First, a customer approaches a user station 15. Using the user interface 12, one of the CDs 11 in stock is selected by the customer (i.e., the customer places an order or otherwise completes a purchasing transaction). The user interface 12 firmware then communicates (via the CPU) to the dispenser 24 associated with that CD 11 that the CD 11 has been selected (the customer input and communication between the user interface 12, in-store server/CPU 22 and dispensers 24 are shown in FIG. 7 by the dashed arrows). Next, if necessary, the motor drive 44c pivots the bridge 44b from the first position to the second position or vice versa (see FIGS. 8a-8b). The appropriate dispenser 24 then dispenses the purchased CD 11 (see FIG. 8c). The purchased CD 11 then slides down the incline of the top funnel 40, through the angled chute 40c and falls through opening 40d (see FIGS. 8d-8e). The CD 11 then lands on the incline of bottom funnel 42 and then falls through opening 42a (see FIG. 8f). Next, the CD 11 lands on bridge 44b and slides down the associated slide path toward the associated dispensing area 16 (see FIGS. 8g-8h). The purchased CD 11 is then received in the dispensing area 16 (see FIG. 8i), at which point the customer can remove the purchased CD 11.

It will be understood that if the CD chosen is dispensed from a dispenser in the bottom row 24b, that the CD will be dispensed directly into the bottom funnel 42 and will never pass through the top funnel 40.

The foregoing embodiments are merely examples of the present invention. Those skilled in the art may make numerous uses of, and departures from, such embodiments without departing from the spirit and the scope of the present invention. Accordingly, the scope of the present invention is not to be limited to or defined by such embodiments in any way, but rather, is defined solely by the following claims.

What is claimed is:

1. A method of vending items, the method comprising the steps of:
a) providing a kiosk having an exterior and an interior,
b) accepting a user interaction with a user interface associated with the exterior of the kiosk,
c) adjusting a slide tray assembly,
d) dispensing from a dispenser an item located in the interior of the kiosk,
e) sliding the item down the slide tray assembly, and
f) receiving the item in a dispensing slot that communicates the interior and exterior of the kiosk.

2. The method of vending items of claim 1 wherein the item is a CD.

3. The method of vending items of claim 2 wherein the method is performed in a fast food establishment.

4. An interactive kiosk comprising:
a) a main body portion having an inner face, an outer face, an interior and an exterior, and wherein the main body portion includes at least one dispensing slot defined therein,
b) a central processing unit,
c) at least one user interface disposed on the outer face of the main body portion, wherein the user interface is in electrical communication with the central processing unit, and
d) a dispensing system disposed in the interior of the main body portion, wherein the dispensing system includes
i) at least one dispenser disposed on the inner face of the main body portion, wherein the dispenser is in electrical communication with the central processing unit,
ii) at least one funnel associated with the at least one dispenser, wherein the at least one funnel has an opening defined therein, and
iii) a slide tray assembly disposed below the at least one funnel, wherein the slide tray assembly is adapted to dispense items to the at least one dispensing slot.

5. The interactive kiosk of claim 4 wherein the dispensing system includes at least a first row of dispensers disposed on the inner face of the main body portion, wherein each of the dispensers in the first row is in electrical communication with the central processing unit, and wherein the at least one funnel is associated with the first row of dispensers.

6. The interactive kiosk of claim 4 wherein the main body portion includes a plurality of dispensing slots, and wherein the dispensing system includes:
a) a first row of dispensers disposed on the inner face of the main body portion, wherein each of the dispensers in the first row is in electrical communication with the central processing unit,
b) a second row of dispensers located below the first row of dispensers, wherein each of the dispensers in the second row is in electrical communication with the central processing unit,
c) a top funnel associated with the first row of dispensers, wherein the top funnel has an opening defined therein, and
d) a bottom funnel associated with the second row of dispensers, wherein the bottom funnel has an opening defined therein,
and wherein the slide tray assembly is disposed below the bottom funnel and is adjustable to dispense items to one or more of the dispensing slots.

7. The interactive kiosk of claim 6 wherein the top funnel includes a top section and a bottom section that cooperate to form an angled chute.

8. The interactive kiosk of claim 4 wherein main body portion includes a plurality of dispensing slots therein, and wherein the slide tray assembly includes:
a) a double ended slide tray having first and second slide portions, and
b) a bridge, wherein the bridge is pivotable by a motor drive to form a first slide path with the first slide portion and a second slide path with the second slide portion.

9. The interactive kiosk of claim 6 wherein the opening in the bottom funnel is covered by a trap door.

10. The interactive kiosk of claim 4 wherein the slide tray assembly is rotatable.

11. The interactive kiosk of claim 4 wherein the items are CDs.

12. An interactive kiosk comprising:
a) a main body portion having an inner face, an outer face, an interior and an exterior, and wherein the main body portion includes a plurality of dispensing slots defined therein,
b) a central processing unit,
c) a plurality of user interfaces disposed on the outer face of the main body portion, wherein the user interfaces are in electrical communication with the central processing unit, and
d) a dispensing system disposed in the interior of the main body portion, wherein the dispensing system includes,
i) a first row of dispensers disposed on the inner face of the main body portion, wherein each of the dispensers in the first row is in electrical communication with the central processing unit,
ii) a second row of dispensers located below the first row of dispensers, wherein each of the dispensers in the second row is in electrical communication with the central processing unit,
iii) a top funnel associated with the first row of dispensers, wherein the top funnel has an opening defined therein,
iv) a bottom funnel associated with the second row of dispensers, wherein the bottom funnel has an opening defined therein, and
v) a slide tray assembly disposed below the bottom funnel, wherein the slide tray is adjustable to dispense items to one or more of the dispensing slots, and wherein the slide tray assembly includes a double ended slide tray having first and second slide portions, and a bridge, wherein the bridge is pivotable by a motor drive to form a first slide path with the first slide portion and a second slide path with the second slide portion.

13. A method of purchasing an entertainment related item, the method comprising the steps of:
a) entering a fast food establishment,
b) approaching a system for the preview and purchase of entertainment related items,
c) interacting with a user interface associated with the system for the preview and purchase of entertainment related items, and
d) purchasing an entertainment related item.
